(19) United States
(12) Patent Application Publication
(10) Pub. No.: US 2023/0177313 A1
(43) Pub. Date: Jun. 8, 2023

(54) Method for Predicting Burning Through Point Based on Encoder-Decoder Network

(71) Applicant: ZHEJIANG UNIVERSITY, Hangzhou (CN)

(72) Inventors: Chunjie YANG, Hangzhou (CN); Feng YAN, Hangzhou (CN); Yuxuan LI, Hangzhou (CN); Chong YANG, Hangzhou (CN)

(73) Assignee: ZHEJIANG UNIVERSITY, Hangzhou (CN)

(21) Appl. No.: 17/837,609

(22) Filed: Jun. 10, 2022

(30) Foreign Application Priority Data
Dec. 6, 2021 (CN) 202111479943.3

(51) Int. Cl. G06N 3/04; G06F 17/11; B22F 3/10

(52) U.S. Cl. CPC G06N 3/0454; B22F 3/10; G06F 17/11

(57) ABSTRACT

A method for predicting burning through point (BTP) based on an encoder-decoder network is provided, which belongs to a field of soft-sensing modeling in an industrial process. A BTP prediction model based on the encoder-decoder network with a temporal attention mechanism and a spatial attention mechanism is developed according to data acquired during an operation of a sintering machine, where the temporal attention mechanism is used to characterize temporal dynamics of samples, and the spatial attention mechanism is used to capture a correlation between an object variable and an advanced feature, to improve accuracy and robustness of the model. With the model, BTP in a sintering process can be predicted in real time, which has great practical significance for on-site process guidance and parameter adjustment.

### CROSS REFERENCE TO RELATED APPLICATION

This patent application claims the benefit and priority of Chinese Patent Application No. 202111479943.3, filed on Dec. 06, 2021, the disclosure of which is incorporated by reference herein in its entirety as part of the present application.

### TECHNICAL FIELD

The present disclosure relates to a soft-sensing method for predicting burning through point (BTP) in a sintering process, and in particular to a method for BTP prediction based on an encoder-decoder network with a temporal attention mechanism and a spatial attention mechanism.

### BACKGROUND

In modern iron-making, the traditional iron and steel production process is still predominant, and blast furnace ironmaking is still regarded as the most efficient, high-output, and energy-saving way to smelt iron ore into pig iron. However, to ensure air permeability of material granules during the blast furnace ironmaking, furnace charge is required to have uniform granularity, little powder, and high mechanical strength.

Sintering, one of main ways to produce artificial lump materials, is a process of heating powdery materials at a high temperature and sintering them into sinter masses under a condition of incomplete melting. The output, quality, and energy consumption of ironmaking are directly affected by the quality of a sinter ore, and an important state parameter for determining the quality of the sinter ore is BTP. BTP has a great influence on the output and quality of the sinter ore. Therefore, to ensure stability of BTP is an important condition for making full use of an effective area of a sintering machine and ensuring high quality, output and cooling efficiency. BTP cannot be detected by an instrument; and for a large sintering machine, it takes about 40 minutes from feeding materials into a pallet to discharging the sinter ore from a tail end of the large sintering machine. Clearly, BTP lags behind a sintering process, which makes BTP difficult to control. Thus, it is necessary to predict a state of BTP before finishing the sintering process, so as to take measures for adjustment in time.

The sintering process is properly determined and BTP is accurately predicted according to real-time process parameters, state parameters, and operating parameters in the sintering process to adjust velocity of the sintering pallet to stabilize BTP, reduce a fluctuation of BTP, and improve control of the output and quality of the sinter ore. In addition, timely prediction on BTP plays a significant role in properly using existing sintering machines, stabilizing sintering production, facilitating a lift-off effect of sintering control level, and improving economic benefits of sintering plants.

### SUMMARY

The present disclosure aims at solving a problem that BTP in a sintering process is difficult to predict by providing a method for BTP prediction based on an encoder-decoder network. The method mainly includes the following four steps: first, selecting auxiliary variables which are convenient to measure and closely related to BTP; then, acquiring and preprocessing data of the sintering process to eliminate influences caused by noises, abnormal data, or the like; next, establishing a data model of the auxiliary variables and BTP by means of the encoder-decoder network, and embedding a temporal attention mechanism and a spatial attention mechanism into an encoder-decoder framework to improve accuracy of a prediction model; and finally, adjusting results of the model, and performing testing in an actual industrial site.

The present disclosure adopts the following technical solutions.

The present disclosure provides a method for BTP prediction based on an encoder-decoder network including the following steps:
(1) determining auxiliary variables related to BTP as input features, reading and preprocessing data of a sintering process from a database; reading data of exhaust-gas temperatures in bellows from the database, and calculating BTP and burning rising point (BRP) with a polynomial fitting method;
(2) segmenting the data with a sliding window method based on the input features to construct training samples, verification samples, and test samples;
(3) establishing a BTP prediction model based on the encoder-decoder network, and training the model by means of the training samples; and
(4) reading, at current time k, on-line historical data from time k - tₕ to time k in real time from a sensor and the database, collecting and preprocessing the auxiliary variables; reading the data of the exhaust-gas temperatures in the bellows from the time k - tₕ to the time k, calculating BTP and BRP with a least square method; segmenting the data with the sliding window method to obtain data segments and establish a many-to-many sequence data set from the time k - tₕ to the time k; and inputting the many-to-many sequence data set into the trained BTP prediction model to obtain a BTP prediction result within a next prediction time length t_{f} from the time k.

As an embodiment of the disclosure, in step (1), the auxiliary variables are selected as: a solid fuel ratio, a quicklime ratio, a limestone ratio, a dolomite-water ratio, a water content after a second mixing, a material thickness, an ignition temperature, air permeability, a negative pressure of a main fan, a pallet velocity, an exhaust-gas temperature of a large flue, and BRP, where all the auxiliary variables except BRP are obtained from the data of the sintering process stored in the database; the auxiliary variables are taken as the input features, and calculated BTP is taken as an output label.

As an embodiment of the disclosure, in step (1), reading the data of the exhaust-gas temperatures in the bellows from the database and calculating BTP and BRP with the polynomial fitting method includes:

regarding the exhaust-gas temperature Tᵢ and a position xᵢ of the bellows at a vicinity of BTP as a quadratic relation which satisfies a formula (1):

$${T}_{i} = \text{a} {x}_{i}^{2} + b {x}_{i} + c \left(i = 1 , 2 , … , m\right)$$

substituting the positions and the exhaust-gas temperatures, (xᵢ, Tᵢ), of the last three bellows into the formula (1) to obtain a linear equation set of the exhaust-gas temperatures and the positions of the bellows, where a subscript i represents the i^{th} bellows to the last bellows; and solving the linear equation set to obtain a:

$$a = \frac{\frac{{T}_{1} - {T}_{2}}{{x}_{1} - {x}_{2}} - \frac{{T}_{2} - {T}_{3}}{{x}_{2} - {x}_{3}}}{{x}_{1} - {x}_{3}}$$

then solving the linear equation set to obtain b:

$$b = \frac{{T}_{1} - {T}_{2}}{{x}_{1} - {x}_{2}} - a \left({x}_{1} + {x}_{2}\right)$$

then:

$$c = {T}_{i} - \text{a} {x}_{i}^{2} - b {x}_{i}$$

obtaining BTP by means of the equations as follows:

$${x}_{m a x} = - \frac{b}{2 a}$$

wherein, BRP refers to a position where the exhaust-gas temperature rise in a length direction of a sintering machine, and the position xₖ corresponding to the exhaust-gas temperature Tₖ of 180° C. is solved based on a following formula:

$${T}_{k} = \text{a} {x}_{k}^{2} + b {x}_{k} + c .$$

As an embodiment of the disclosure, in step (2), sampling is performed with a sliding time window segment method, and each input segment sample is expressed as a matrix:

$$X ∈ {R}^{{T}_{h} \times f}$$

where, Tₕ represents the number of frames of an observation segment, ƒ represents the number of features of the segment; and an output sample Y is set to correspond to each input sample X:

$$Y ∈ {R}^{{T}_{f} \times f} .$$

As an embodiment of the disclosure, in step (3), establishing the BTP prediction model based on the encoder-decoder network particularly includes: establishing the model by means of a encoder-decoder framework, wherein an encoder is established by means of a gated recurrent unit (GRU), and feature data are input in time series to obtain an output, namely an advanced feature, of the encoder; then calculating a correlation between a hidden state vector and an advanced feature vector of a decoder by means of a temporal attention mechanism to obtain a weight coefficient between them; and calculating a correlation between the output label and the advanced feature by means of a spatial attention mechanism to establish a potential correlation between an object variable and the advanced feature.

As an embodiment of the disclosure, parameters of the BTP prediction model are adjusted in real time according to real-time data of the sintering process for continuous iteration for optimization, so that the model has high robustness.

The present disclosure has the following beneficial effects: in the method of the present disclosure, the auxiliary variables having an influence on BTP are fully considered, such as an introduction of BRP, to improve prediction accuracy of the model; a many-to-many sequence is modeled with an encoder-decoder model to perform a multi-step BTP prediction, thereby achieving a BTP prediction in advance; and with the temporal attention mechanism and the spatial attention mechanism, dynamics of time series can be captured, and the correlation between the object variable and the advanced feature can be learned, so that accuracy and robustness of the model are further improved.

### BRIEF DESCRIPTION OF THE DRAWINGS

In order to describe embodiments of the present disclosure or technical solutions in the existing art more clearly, drawings required to be used in the embodiments will be briefly introduced below. It is apparent that the drawings in the descriptions below are only some embodiments of the present disclosure. Those of ordinary skill in the art also can obtain other drawings according to these drawings without making creative work.

FIG. 1 shows a construction and application diagram of a BTP prediction model based on an encoder-decoder network;

FIG. 2 shows a classification chart of variables in a sintering process;

FIG. 3 shows a fitting curve of exhaust-gas temperatures of bellows;

FIG. 4 shows a schematic diagram illustrating segmentation of data;

FIG. 5 shows a basic recurrent network and various prediction tasks;

FIG. 6 shows an encoder-decoder framework;

FIG. 7 shows an encoder-decoder framework with a temporal attention mechanism and a spatial attention mechanism; and

FIG. 8 shows curves illustrating comparison results between an encoder-decoder prediction model and other models.

### DETAILED DESCRIPTION

The technical solutions in the embodiments of the present disclosure will be described below clearly and completely with reference to the accompanying drawings in the embodiments of the present disclosure. Apparently, the described embodiments are merely some rather than all of the embodiments of the present disclosure. All other embodiments derived from the embodiments of the present disclosure by a person of ordinary skill in the art without creative efforts shall fall within the protection scope of the present disclosure.

An objective of the present disclosure is to provide a method and system for global stabilization control of a hypersonic vehicle that enable the global stabilization control of a non-minimum phase hypersonic vehicle.

To make the above-mentioned objective, features, and advantages of the present disclosure clearer and more comprehensible, the present disclosure will be further described in detail below in conjunction with the accompanying drawings and specific embodiments.

The following clearly and more completely describes the technical solution in the embodiments of the present disclosure in combination with the accompanying drawings of the embodiments of the present disclosure. Apparently, the described embodiments are only part of the embodiments of the present disclosure, not all embodiments. Based on the embodiments in the present disclosure, all other embodiments obtained by those of ordinary skill in the art without creative work shall fall within the protection scope of the present disclosure.

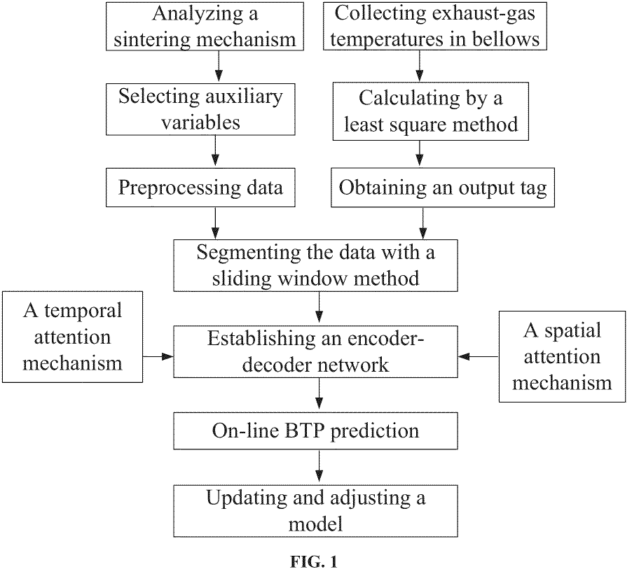

FIG. 1 shows specific steps of constructing and applying a BTP prediction model based on an encoder-decoder network with a temporal attention mechanism and a spatial attention mechanism. The specific steps include (1)-(4).
(1) Auxiliary variables related to BTP are determined as input features, data of a sintering process are read and preprocessed from a database; data of exhaust-gas temperatures in bellows are read from the database, and BTP and BRP are calculated with a polynomial fitting method;
(2) The data are segmented with a sliding window method based on the input features to construct training samples, verification samples, and test samples;
(3) The BTP prediction model is established based on the encoder-decoder network, and the model is trained by means of the training samples; and
(4) At current time k, on-line historical data from time k - tₕ to time k in real time are read from a sensor and the database, the auxiliary variables are collected and preprocessed; the data of the exhaust-gas temperatures in the bellows from the time k - tₕ to the time k are read, BTP and BRP are calculated with a least square method; the data are segmented with the sliding window method to obtain data segments and establish a many-to-many sequence data set from the time k - tₕ to the time k; and the many-to-many sequence data set is input into the trained BTP prediction model to obtain a BTP prediction result within a next predication time length t_{f} from the time k. In a specific embodiment of the present disclosure, a time width from the time k - tₕ to the time k may be set as 45 minutes (tₕ = 45), and the predication time length t_{f} may be set as 10 minutes (t_{f} = 10).

The present disclosure will be further described below in conjunction with specific embodiments.

### Analysis of Sintering Mechanism and Classification of Variables

This experiment is performed with a 360 m² sintering machine manufactured by an Iron and Steel Company in Southern China. Sintering is a process in which sintered mixtures are changed from powder to solid blocks at a high temperature. Particularly, iron ore powder, solvents, fuel, and return ore are batched according to a certain proportion, mixed with water to obtain granules to be transported to a mixture bunker by a belt conveyor. Then, the granules are spread on a belt sintering machine by a feeder. The fuel contained in the mixture is ignited by an igniter at a certain negative pressure. Fume is pumped by an exhaust fan from top to bottom. The mixture is melted and burned from top to bottom during movement of a sintering pallet. A large amount of heat is generated by burning the fuel to melt a surface of the powder iron ore to generate a certain amount of liquid, so as to moisten unmelted ore granules, so that the sinter ore granules are bonded into blocks. Finally, burnt-through finished sinter ore is transported to a tail end of the sintering machine and discharged from it, crushed by a single roller, and transported to a granulation system. And except for hearth layers and return ore for sintering, the rest in products are sent into a blast furnace as the finished sinter ore.

### Construction of Variables in Sintering Process

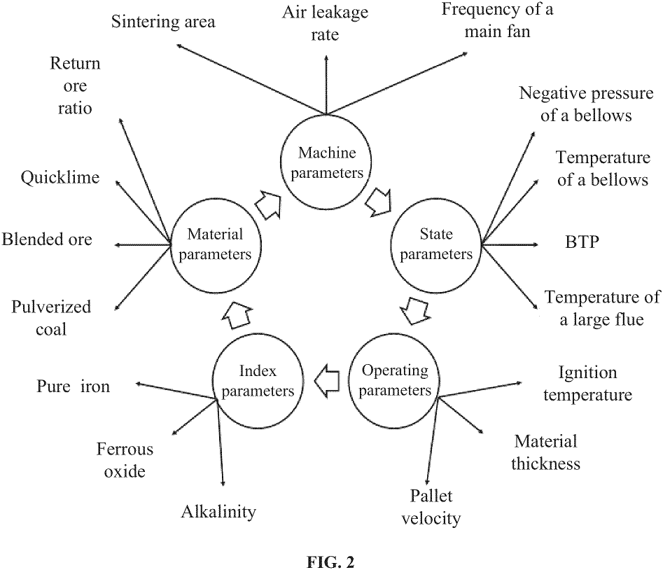

The sintering process is a dynamic time-varying process which has complex mechanisms, numerous influencing factors, indeterminacy, strong nonlinearity, large lagging property, and high coupling. For better understanding a relation between the sintering process and the variables, the variables in the sintering process are systematically induced as shown in FIG. 2.

The sintering process of the iron ore may be regarded as a system: once some operating parameters and material parameters have an effect on machine parameters, some index parameters and state parameters will correspond to these parameters, and their relation is expressed as follows:

(operating parameters, material parameters, machine parameters)-( state parameters, index parameters).

The material parameters include: an iron-containing material ratio, a fuel ratio and a solvent ratio.

The operating parameters include: water addition in the first mixing, water addition in the second mixing, a pallet velocity and a material thickness.

The machine parameters include: exhaust capacity and an exhaust area of a large fan, air leakage rate of the sintering machine, and the like.

The state parameters include: air permeability of a material layer, a negative pressure of a main tube, the exhaust-gas temperatures of the bellows, BTP, and the like.

The index parameters include: output of the sinter ore, chemical component, mechanical strength, reducibility, and the like.

By means of analysis of the sintering mechanism, literature research and statistical analysis of data, it may be determined that factors affecting BTP include: a solid fuel ratio, a limestone fuel ratio, the pallet velocity of the sintering machine, a temperature of the bellows at BRP of a sintered exhaust-gas, an ignition temperature, the material thickness, a water content after the second mixing, current BTP, and the like, as shown in table 1.

TABLE 1

Input parameters of the model and BTP

| | |
|---|---|
| Variable | Name |
| X₁ | Solid fuel ratio/% |
| X₂ | Quicklime ratio/% |
| X₃ | Limestone ratio/% |
| X₄ | Dolomite-water ratio/% |
| X₅ | Water content after the second mixing/% |
| X₆ | Material thickness/mm |
| X₇ | Ignition temperature/°C |
| X₈ | Air permeability |
| X₉ | Negative pressure of a main fan /kPa |
| X₁₀ | Pallet velocity (m/min) |
| X₁₁ | exhaust-gas temperature of a large flue/°C |
| X₁₂ | BRP/m |
| Y | BTP/m |

### Calculation of BTP

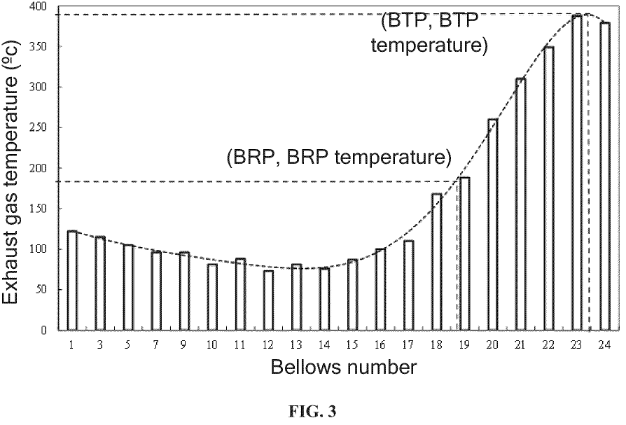

The exhaust-gas temperatures of the bellows are read from the database. A soft-sensing model is established according to a mathematical relation between the exhaust-gas temperatures of the bellows and BTP. Considering that the maximum exhaust-gas temperature is reached when the mixtures are just burned through during the sintering process, BTP can be found based on the exhaust-gas temperature of the bellows at the tail end of the sintering machine. The curve of the exhaust-gas temperatures of the bellows is shown in FIG. 3. The exhaust-gas temperature Tᵢ and a position xᵢ of a bellows at a vicinity of BTP are approximately regarded as a quadratic relation which satisfies a formula (1):

$${T}_{i} = \text{a} {x}_{i}^{2} + b {x}_{i} + c \left(i = 1 , 2 , … , m\right)$$

The positions and the exhaust-gas temperatures, (xᵢ, TL), of the last three bellows are substituted into the formula (1) to obtain a linear equation set of the exhaust-gas temperatures and the positions of the bellows, where a subscript i represents the i^{th} bellows to the last bellows. The linear equation set is solved to obtain a:

$$\text{a} = \frac{\frac{{T}_{1} - {T}_{2}}{{x}_{1} - {x}_{2}} - \frac{{T}_{2} - {T}_{3}}{{x}_{2} - {x}_{3}}}{{x}_{1} - {x}_{3}}$$

Then the linear equation set is solved to obtain b:

$$\text{b} = \frac{{T}_{1} - {T}_{2}}{{x}_{1} - {x}_{2}} - a \left({x}_{1} + {x}_{2}\right)$$

Then:

$$\text{c} = {T}_{i} - \text{a} {x}_{i}^{2} - b {x}_{i}$$

BTP is obtained by means of the equation as follows:

$${x}_{m a x} = - \frac{b}{2 a}$$

At a sintering site, sealing measures of the bellows at the tail end of the sintering machine are incomplete due to air leakage, causing that a measured value is less than an actual value of the exhaust-gas temperature of the bellows. In view of this, a correction coefficient, namely a feedback coefficient of a large flue, is introduced to guarantee accuracy in the calculation of BTP as follows:

$$B T {P}_{m} = B T {P}^{′} - α \text{Δ} \text{T}$$

Where, BTPₘ represents a corrected value of BTP, BTP′ represents a calculated value of BTP, AT represents a temperature deviation between the measured value and actual value of the exhaust-gas temperature, a represents the correction coefficient and is generally set as 0.02.

BRP refers to a position where the exhaust-gas temperature rises in a length direction of the sintering machine, and the position xₖ corresponding to the exhaust-gas temperature of 180° C. (Tₖ = 180) is solved based on the following formula:

$${T}_{k} = \text{a} {x}_{k}^{2} + b {x}_{k} + c$$

### Segmentation of Data

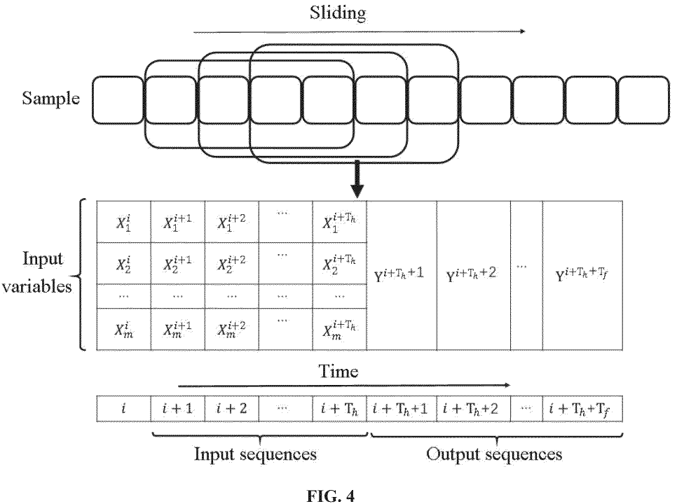

As shown in FIG. 4, sampling is performed with a sliding time window segment method. Adopting a sliding time window in the segment division for sampling can directly solve problems of few data files and short acquisition time, and reduce an influence of errors of individual coordinate data on determining a movement mode. In order to facilitate a data operation, each input segmented sample is expressed as a matrix:

$$X ∈ {R}^{{T}_{h} \times f}$$

where, Tₕ represents the number of frames of an observation segment, f represents the number of features of the segment; and an output sample Y is set to correspond to each input sample X:

$$Y ∈ {R}^{{T}_{f} \times f}$$

In this way, a serial data set is established for subsequent model input.

### BTP Prediction Model Based on Encoder-Decoder Network

### Step 1, Off-Line Modelling

Step 1.1, 12 key variables, such as material ratio, the pallet velocity, the air permeability of the material layer, BRP, and other key variables, are determined as the input features of the model by means of the analysis of the sintering mechanism. The data are read from the database in real time, and preprocessings such as data filtering, data smoothing and data normalization are performed.

Step 1.2, the exhaust-gas temperatures in the bellows are read from the database. BTP and BRP are calculated with a polynomial fitting method. The data are segmented with the sliding window method based on the input features to construct the training samples, the verification samples, and the test samples.

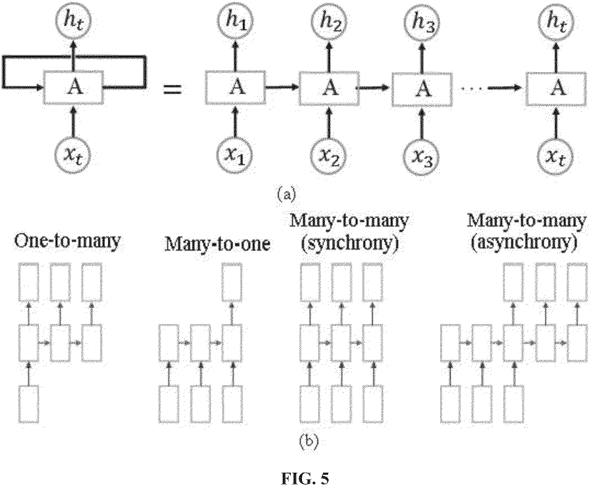

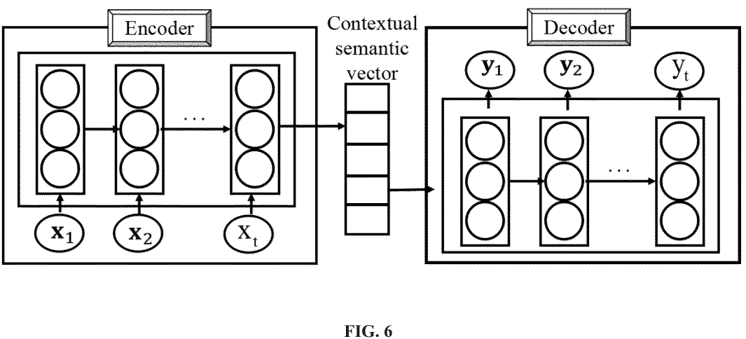

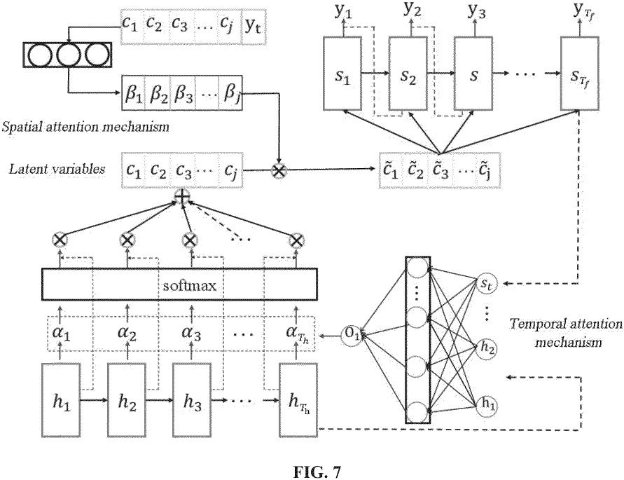

Step 1.3, FIG. 5 illustrates a basic recurrent network and typical prediction tasks, since BTP is a many-to-many sequence prediction model, a encoder-decoder framework is used for modeling. Firstly, an encoder is established by means of a GRU, and feature data are input in time series to obtain an output, namely an advanced feature, of the encoder. Then, a correlation between a hidden state vector and an advanced feature vector of a decoder is calculated by means of the temporal attention mechanism to obtain a weight coefficient between them. A correlation between an output label and the advanced feature is calculated by means of the spatial attention mechanism to establish a potential correlation between an object variable and the advanced feature, as shown in FIG. 6 and FIG. 7. Finally, BTP series are continuously generated by the trained model to fulfill prediction on BTP. Formulas of the temporal attention mechanism are as follows:

$${e}_{( t )}^{j} = s c o r e \left({h}_{( t - T + f )} , {s}_{( t - 1 )}\right) = {V}_{l}^{j} tanh \left({W}_{t}^{j} \left[{h}_{\left(t - T + f\right)} , {s}_{( t - 1 )}\right] + {b}_{l}^{j}\right)$$

$${α}_{\left(t\right)}^{j} = \frac{exp \left({e}_{\left(t\right)}^{j}\right)}{{\sum }_{j = 1}^{T} exp \left({e}_{\left(t\right)}^{j}\right)}$$

$${x}_{\left(t\right)} = {\sum }_{j} {α}_{\left(t\right)}^{j} {h}_{\left(j - T + 1\right)}$$

$${c}_{\left(t\right)} = tanh \left({x}_{\left(t\right)} , {s}_{\left(t - 1\right)}\right)$$

where, h_{(t-T+j)} represents a hidden unit of the encoder, S₍ₜ₋₁₎ represents a hidden unit of the decoder at previous time,

$${V}_{l}^{j} , {W}_{l}^{j} , a n d {b}_{l}^{j}$$

represent parameters that the model needs to learn,

$${α}_{( t )}^{j}$$

represents a value of the temporal attention mechanism, and c₍ₜ₎ represents the advanced feature or a contextual semantic vector.

The spatial attention mechanism is expressed as follows:

$${e}_{\left(t\right)}^{k} = s c o r e \left({c}_{\left(t\right)} , {y}_{\left(t - 1\right)}\right) = {V}_{l}^{k} tanh \left({W}_{l}^{k} \left[{c}_{\left(t\right)} , {y}_{\left(t - 1\right)}\right] + {b}_{l}^{k}\right)$$

$${β}_{\left(t\right)}^{k} = \frac{exp \left({e}_{\left(t\right)}^{k}\right)}{{\sum }_{k = 1}^{T} exp \left({e}_{\left(t\right)}^{k}\right)}$$

$${\tilde{c}}_{\left(t\right)} = \left({β}_{\left(t\right)}^{1} {c}_{t}^{1} , {β}_{\left(t\right)}^{2} {c}_{t}^{2} , {β}_{\left(t\right)}^{3} {c}_{t}^{3} , … , {β}_{\left(t\right)}^{n} {c}_{t}^{n}\right)$$

where, flk (t) represents an attention value of each dimension of a latent variable c₍ₜ₎, and c₍ₜ₎ represents an advanced variable after an action of the spatial attention mechanism.

### Step 2: On-Line Detection

Step 2.1, on-line data are read in real time from the sensor and the database, and the auxiliary variables are collected and preprocessed. The data of the exhaust-gas temperatures in the bellows are read. BTP and BRP are calculated with the least square method. The data are segmented with the sliding window method to obtain data segments and establish the many-to-many sequence data set. Then, the established prediction model is deployed into a sintering expert system to perform on-line prediction according to the real-time data. Finally, process parameters are adjusted in time according to the BTP prediction result to achieve desired BTP.

### Step 3: Update of Model

The parameters of the encoder-decoder model are adjusted in real time according to the real-time data during the sintering process, and the step 1 is repeated for continuous iteration and optimization so as to fulfill high robustness of the model.

### Test of Model Performance

In order to test effectiveness of the model, 10000 samples are collected from a certain sintering plant with an interval of one minute and are segmented with the sliding window method. After data preprocessing, data segments are divided into 6000 training samples, 1000 verification samples, and 785 test samples. Because it is troublesome to adjust parameters of a deep learning model, the parameters of the model are set as shown in table 2 below through an experiment.

TABLE 2

Hyperparameters of model

| Parameter | Hidden size | Learning rate | Hidden_layer | Dropout | Input_size | Output_size |
|---|---|---|---|---|---|---|
| Value | 20 | 0.001 | 2 | 0.1 | 40 | 3 |

In order to test the performance of the established model, two traditional machine learning models, namely a vector autoregression (VAR) model and an autoregressive integrated moving average (ARIMA) model, and two deep recurrent networks, namely a long short-term memory (LSTM) network and a GRU network, are adopted as comparison models. Evaluation indexes are a determination coefficient, a root-mean-square error, and a mean absolute error, as shown in the following formulas:

$${R}^{2} = \frac{{\sum }_{i = 1}^{n} {\left({\tilde{y}}^{\left(i\right)} - \overline{y}\right)}^{2}}{{\sum }_{i = 1}^{n} {\left({y}^{\left(i\right)} - \overline{y}\right)}^{2}}$$

$$\text{MAE =} \frac{1}{n} {\sum }_{i = 1}^{n} \left|{\tilde{y}}^{\left(i\right)} - y\right|$$

$$\text{RMSE=} \sqrt{\frac{1}{n} {\left({\tilde{y}}^{\left(i\right)} - y\right)}^{2}}$$

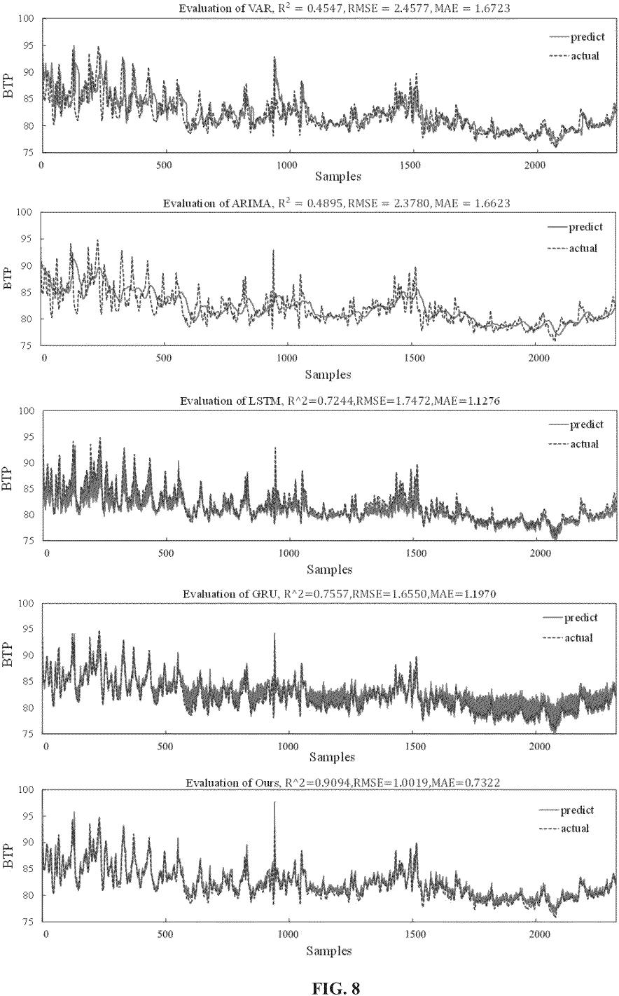

Table 3 and FIG. 8 show a prediction effect of the encoder-decoder model with the temporal attention mechanism and the spatial attention mechanism. It can be seen that the two traditional machine learning models, the VAR model and the ARIMA model, have poor performance in multi-step prediction, and accuracy of the two models does not reach 50%, which indicates that statistical learning models have certain limitations for a complex industrial process, but the performance of the two deep learning models, the LSTM network and the GRU network, has greatly improved and the accuracy has greater than 70%. However, for an industrial site, the BTP prediction model cannot be used. The encoder-decoder model achieves better performance for the many-to-many sequence prediction and the accuracy is about 90%, which improves the accuracy in prediction on BTP, provides sufficient time for sintering operators to adjust the process parameters, and improves the output and quality of the sinter ore. For sintering plants, advance prediction of BTP will bring great economic benefits to enterprises.

TABLE 3

Comparison of prediction results of the models

| Models | R² | RMSE | MAE |
|---|---|---|---|
| VAR | 0.4547 | 2.4577 | 1.6723 |
| ARIMA | 0.4895 | 2.3780 | 1.6623 |
| LSTM | 0.7244 | 1.7472 | 1.1276 |
| GRU | 0.7557 | 1.6550 | 1.1970 |
| Ours | 0.9094 | 1.0019 | 0.7322 |

The embodiments are described herein in a progressive manner. Each embodiment focuses on the difference from another embodiment, and the same and similar parts between the embodiments may refer to each other. Since the system disclosed in an embodiment corresponds to the method disclosed in another embodiment, the description is relatively simple, and reference can be made to the method description.

The principle and implementation modes of the present disclosure are described by applying specific examples in the present disclosure. The descriptions of the above embodiments are only intended to help to understand the method of the present disclosure and a core idea of the method. In addition, those ordinarily skilled in the art can make changes to the specific implementation modes and the application scope according to the idea of the present disclosure. From the above, the contents of this specification shall not be deemed as limitations to the present disclosure.

What is claimed is:

1. A method for predicting burning through point (BTP) based on an encoder-decoder network, comprising:
a first step determining auxiliary variables related to BTP as input features, reading and preprocessing data of a sintering process from a database; reading data of exhaust-gas temperatures in bellows from the database, and calculating BTP and burning rising point (BRP) with a polynomial fitting method;
a second step segmenting the data with a sliding window method based on the input features to construct training samples, verification samples, and test samples;
a third step establishing a BTP prediction model based on the encoder-decoder network, and training the model by means of the training samples; and
a fourth step reading, at current time k, on-line historical data from time k - tₕ to time k in real time from a sensor and the database, collecting and preprocessing the auxiliary variables; reading the data of the exhaust-gas temperatures in the bellows from the time k -tₕ to the time k, calculating BTP and BRP with a least square method; segmenting the data with the sliding window method to obtain data segments and establish a many-to-many sequence data set from the time k - tₕ to the time k; and inputting the many-to-many sequence data set into the trained BTP prediction model to obtain a BTP prediction result within a next prediction time length t_{f} from the time k.

2. The method for predicting BTP based on the encoder-decoder network according to claim 1, wherein in the first step, the auxiliary variables are selected as: a solid fuel ratio, a quicklime ratio, a limestone ratio, a dolomite-water ratio, a water content after a second mixing, a material thickness, an ignition temperature, air permeability, a negative pressure of a main fan, a pallet velocity, an exhaust-gas temperature of a large flue, and BRP, wherein all the auxiliary variables except BRP are obtained from the data of the sintering process stored in the database; the auxiliary variables are taken as the input features, and calculated BTP is taken as an output label.

3. The method for predicting BTP based on the encoder-decoder network according to claim 1, wherein, in the first step, reading the data of the exhaust-gas temperatures in the bellows from the database and calculating BTP and BRP with the polynomial fitting method comprises:
regarding the exhaust-gas temperature Tᵢ and a position xᵢ of the bellows at a vicinity of BTP as a quadratic relation which satisfies a first formula:
$${T}_{i} = \text{a} {x}_{i}^{2} + b {x}_{i} + c \left(i = 1 , 2 , … , m\right)$$
substituting the positions and the exhaust-gas temperatures, (xᵢ,Tᵢ of last three bellows into the first formula to obtain a linear equation set of the exhaust-gas temperatures and the positions of the bellows, wherein a subscript i represents an i^{th} bellows to a last bellows; and solving the linear equation set to obtain a:
$$a = \frac{\frac{{T}_{1} - {T}_{2}}{{x}_{1} - {x}_{2}} - \frac{{T}_{2} - {T}_{3}}{{x}_{2} - {x}_{3}}}{{x}_{1} - {x}_{3}}$$
then solving the linear equation set to obtain b:
$$b = \frac{{T}_{1} - {T}_{2}}{{x}_{1} - {x}_{2}} - a \left({x}_{1} + {x}_{2}\right)$$
then:
$$\text{c} = {T}_{i} - \text{a} {x}_{i}^{2} - b {x}_{i}$$
obtaining BTP by means of the equations as follows:
$${x}_{m a x} = - \frac{b}{2 a}$$
wherein, BRP refers to a position where the exhaust-gas temperature rise in a length direction of a sintering machine, and the position xₖ corresponding to the exhaust-gas temperature Tₖ of 180° C. is solved based on a following formula:
$${T}_{k} = \text{a} {x}_{k}^{2} + b {x}_{k} + c .$$
.

4. The method for predicting BTP based on the encoder-decoder network according to claim 1, wherein, in the second step, sampling is performed with a sliding time window segment method, and each input segment sample is expressed as a matrix:
$$X ∈ {R}^{{T}_{h} \times f}$$
wherein, Tₕ represents a number of frames of an observation segment, f represents a number of features of the segment; and an output sample Y is set to correspond to each input sample X:
$$Y ∈ {R}^{{T}_{f} \times f} .$$
.

5. The method for predicting BTP based on the encoder-decoder network according to claim 1, wherein, in the third step, establishing the BTP prediction model based on the encoder-decoder network comprises:
establishing the model by means of a encoder-decoder framework, wherein an encoder is established by means of a gated recurrent unit (GRU), and feature data are input in time series to obtain an output, namely an advanced feature, of the encoder; then calculating a correlation between a hidden state vector and an advanced feature vector of a decoder by means of a temporal attention mechanism to obtain a weight coefficient between them; and calculating a correlation between an output label and the advanced feature by means of a spatial attention mechanism to establish a potential correlation between an object variable and the advanced feature.

6. The method for predicting BTP based on the encoder-decoder network according to claim 1, wherein parameters of the BTP prediction model are adjusted in real time according to real-time data of the sintering process for continuous iteration and optimization, so that the model has high robustness.
